(19) United States
(12) Patent Application Publication
(10) Pub. No.: US 2025/0320702 A1
(43) Pub. Date: Oct. 16, 2025

(54) PLUMBING FIXTURE FOR A SHOWER SYSTEM

(71) Applicant: GROHE AG, Hemer (DE)

(72) Inventors: Andreas Jung, Froendenberg (DE); Thilo Finkeldei, Nideggen (DE)

(73) Assignee: GROHE AG, Hemer (DE)

(21) Appl. No.: 18/713,004

(22) PCT Filed: Nov. 15, 2022
(86) PCT No.: PCT/EP2022/082021

§ 371 Date: Oct. 28, 2024

(30) Foreign Application Priority Data
Nov. 29, 2021 (DE) 10 2021 131 210.8

(51) Int. Cl. E03C 1/10

(52) U.S. Cl. CPC E03C 1/106

(57) ABSTRACT

The invention relates to a plumbing fixture (1) for a shower system (2), at least comprising
a supply line (3) for supplying at least one liquid towards an outlet (4) of the plumbing fixture (1);
a first connection (5) to the supply line (3) for switchably connecting the supply line (3) to a compressed-air line (6);
   wherein a liquid present in the supply line (3) can be purged through the outlet (4) via the compressed-air line (6).

The present invention relates to a plumbing fixture for a shower system with which a liquid can be supplied to a shower as needed.

When circulating water is used within a shower system (reuse of already used shower water using the recycling process), the piping system which has come into contact with recycled water is flushed with fresh water after showering. This is to prevent residues of, e.g., skin flakes, soaps, cleaning agents, etc. within the water paths from promoting the growth of bacteria due to their biological composition.

The object of the invention is therefore to at least partially solve the problems described with reference to the prior art and, in particular, to specify a plumbing fixture with which the flushing of supply lines can be improved.

This object is achieved with a sanitary fitting according to the features of the independent patent claim. Further advantageous embodiments of the invention are specified in the dependent claims. It should be noted that the features listed individually in the dependent claims can be combined with one another in any technologically meaningful way and define further embodiments of the invention. Moreover, the features specified in the claims are further refined and explained in more detail in the description, wherein further preferred embodiments of the invention are illustrated.

This is promoted by a plumbing fixture for a shower system which comprises at least the following:
a supply line for supplying at least one liquid (e.g. water, or fresh water or circulating water) towards an outlet of the plumbing fixture, and
a first connection to the supply line for switchably connecting the supply line to a compressed-air line.

A liquid present in the supply line can be purged through the outlet via the compressed-air line.

In particular, the plumbing fixture comprises components that can be installed in a shower system. In particular, the plumbing fixture described can be connected to known components such as a control unit or actuating unit, shower head, drain, etc. The liquid can exit the supply line via the outlet. The liquid exiting the supply line can be used by a user for showering. The used liquid can be fed into a wastewater line via a drain. Alternatively or additionally, a collecting device can also be provided for the liquid that has exited the supply line so that the liquid can be fed again to the supply line as circulating water.

The plumbing fixture can be used in particular to prevent the presence of stagnant water in the supply lines (water lines) of a shower. The shower can be operated with fresh water and/or reused water (recycled water, recirculated water). As a result, the germination potential (measured in colony-forming units (CFU) per unit volume [CFU/ml]) can be significantly reduced.

The stagnant water in the supply line is avoided in particular by purging with compressed air. In particular, a pump is used that can suck in gas mixtures in addition to liquids. The use of two separate pumps (one for water, one for compressed air) is also conceivable.

In particular, either circulating water or compressed air can be supplied towards the outlet via a 3-way valve in the suction line of this pump.

By purging the supply line with compressed air, the number of colony-forming units in the stagnant water or their nutritional basis can be significantly reduced. Even after the shower system has not been used for a long time, no potentially contaminated water is drawn from the shower head or shower connected to the outlet.

Potential back-suction of contaminated water into the respective water line due to negative pressure in the domestic water network can be prevented.

In particular, the plumbing fixture comprises at least one second connection to the supply line for switchably connecting the supply line to a first water line. The first water line can be used to flush the supply line with fresh water.

In particular, a first non-return valve, which prevents a backflow of water or compressed air from the supply line into the first water line, is arranged between the second connection and the first water line.

In particular, at least the first connection or the second connection, preferably both connections, comprises a switchable valve.

Switching the valve can be done manually or automatically, e.g. triggered by use of the shower system. The supply line can be connected in particular to the compressed-air line and/or to the first water line via the valve. The valve, for example, can have two inputs and one output in each case. The inputs are connected, for example, to the inflow of the supply line and the water line or the compressed-air line. The output is connected to the outflow of the supply line towards the outlet.

In particular, the first connection and the second connection are connected to the supply line via a common valve. The output is connected to the outflow of the supply line towards the outlet.

In this case, the valve can have three inputs, for example. The inputs are then connected to the inflow of the supply line, the water line, and the compressed-air line.

Via the valve, each of the inputs can be connected to the output in a switchable manner.

In particular, the plumbing fixture comprises at least one pump for supplying the liquid, or for supplying the compressed air, or for supplying a mixture of liquid and compressed air mixture.

In particular, the at least one pump is arranged between the outlet and the connections (the first connection and the second connection). The inlet of the pump is thus connected to the connections, and the outlet of the pump is connected to the outlet.

In particular, the plumbing fixture comprises at least one third connection to the supply line for connecting the supply line to a second water line.

In particular, a second non-return valve, which prevents a backflow of water or compressed air from the supply line into the second water line, is arranged between the third connection and the second water line.

In particular, mixed water (thus, a mixture of cold water and hot water) from a known mixer tap can be fed to the supply line via the second water line.

The mixer tap can have a mixing valve for mixing cold water and hot water to form mixed water with a desired mixed water temperature. The cold water can be fed to the mixing valve in particular via a cold water line and the hot water via a hot water line. The cold water can have a cold water temperature that is in particular a maximum of 25° C. (Celsius), preferably 1° C. to 25° C., particularly preferably 5° C. to 20° C. The hot water can have a hot water temperature that is in particular a maximum of 90° C., preferably 25° C. to 90° C., particularly preferably 55° C. to 65° C.

In particular, the shower system has a collecting device for the liquid that has exited the outlet, wherein the supply line is fluidically connected to the collecting device so that the liquid can be used as a circulating liquid.

In particular, the second connection is arranged between the collecting device and the at least one further (i.e. the first and/or the third) connection.

The invention and the technical environment are explained in more detail below with reference to the FIGURE. It should be noted that the FIGURE shows a particularly preferred embodiment variant of the invention, but is not limited thereto.

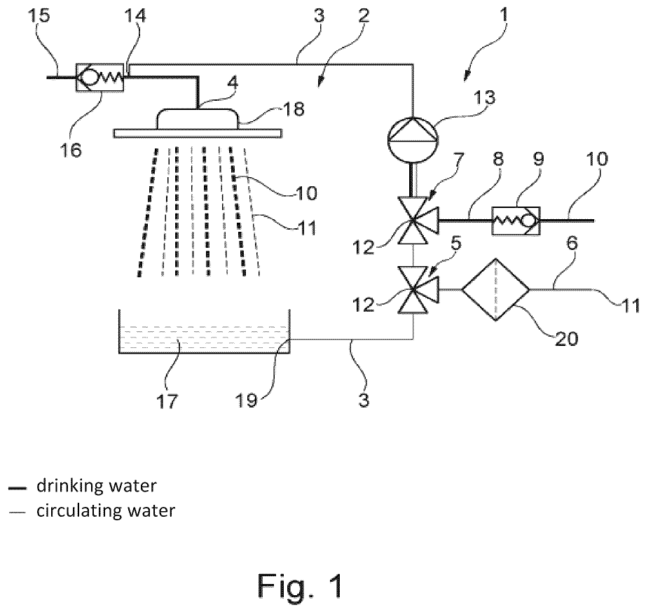

FIG. 1 shows an exemplary and schematic plumbing fixture.

The plumbing fixture 1 is provided for a shower system 2. The plumbing fixture 1 comprises components that can be installed in a shower system 2. The described plumbing fixture 1 is connected to the known components, such as the control unit or actuating unit (not shown), shower head 18, and drain 19. The liquid can exit the supply line 3 via the outlet 4. The liquid that has exited the supply line 3 can be used by a user for showering. The shower system 2 has a collecting device 17 for the liquid exiting the outlet 4, wherein the supply line 3 is fluidically connected to the collecting device 17 via the drain 19, so that the liquid can be used as a circulating liquid.

The plumbing fixture 1 comprises a supply line 3 for supplying at least one liquid (e.g. water, or fresh water or circulating water) towards an outlet 4 of the plumbing fixture 1 and a first connection 5 to the supply line 3 for switchably connecting the supply line 3 to a compressed-air line 6. A liquid present in the supply line 3 can be purged through the outlet 4 via the compressed-air line 6. A filter 20 is arranged in the compressed-air line 6.

The plumbing fixture 1 comprises a second connection 7 to the supply line 3 for switchably connecting the supply line 3 to a first water line 8. The first water line 8 can be used to flush the supply line 3 with fresh water.

A first non-return valve 9, which prevents a backflow of water 10 or compressed air 11 from the supply line 3 into the first water line 8, is arranged between the second connection 7 and the first water line 8.

The first connection 5 and the second connection 7 each comprise a switchable valve 12. Switching the valve 12 can be done manually or automatically, e.g. triggered by use of the shower system 2. The supply line 3 can be connected to the compressed-air line 6 or to the first water line 8 via the respective valve 12. Each valve 12 has two inputs and one output. The inputs are connected to the inflow of the supply line 3 and the first water line 8 or the compressed-air line 6. The output is connected to the outflow of the supply line 3 towards the outlet 4. Each of the inlets can be switchably connected to the output via the respective valve 12.

The plumbing fixture 1 comprises a pump 13 for supplying the liquid, or for supplying the compressed air, or for supplying a mixture of liquid and compressed air through the supply line 3. The pump 13 is arranged between the outlet 4 and the connections 5, 7. The inlet of the pump 13 is thus connected to the connections 5, 7, and the outlet of the pump 13 is connected to the outlet 4.

The plumbing fixture 1 comprises a third connection 14 to the supply line 3 for connecting the supply line 3 to a second water line 15. A second non-return valve 16, which prevents a backflow of water 10 or compressed air 11 from the supply line 3 into the second water line 15, is arranged between the third connection 14 and the second water line 15. Mixed water (i.e. a mixture of cold water and hot water) from a known mixer tap can be supplied to the supply line 3 via the second water line.

### REFERENCE LIST

1 plumbing fixture
2 shower system
3 supply line
4 outlet
5 first connection
6 compressed-air line
7 second connection
8 first water line
9 first non-return valve
10 water
11 compressed air
12 valve
13 pump
14 third connection
15 second water line
16 second non-return valve
17 collecting device
18 shower head
19 drain
20 filter

1. A plumbing fixture (1) for a shower system (2), at least comprising
a supply line (3) for supplying at least one liquid towards an outlet (4) of the plumbing fixture (1);
a first connection (5) to the supply line (3) for switchably connecting the supply line (3) to a compressed-air line (6);
wherein a liquid present in the supply line (3) can be purged through the outlet (4) via the compressed-air line (6).

2. The plumbing fixture (1) according to claim 1, at least comprising a second connection (7) to the supply line (3) for switchably connecting the supply line (3) to a first water line (8).

3. The plumbing fixture (1) according to claim 2, wherein a first non-return valve (9), which prevents a backflow of water (10) or compressed air (11) from the supply line (3) into the first water line (8), is arranged between the second connection (7) and the first water line (8).

4. The plumbing fixture (1) according to any one of the preceding claims, wherein at least the first connection (5) or the second connection (7) comprises a switchable valve (12).

5. The plumbing fixture (1) according to claim 3, wherein the first connection (5) and the second connection (7) are connected to the supply line (3) via a common valve (12).

6. The plumbing fixture (1) according to any one of the preceding claims, at least comprising at least one pump (13) for supplying the liquid, or for supplying the compressed air (11), or for supplying a mixture of liquid and compressed air.

7. The plumbing fixture (1) according to claim 6, wherein the at least one pump (13) is arranged between the outlet (4) and the connections (5, 7).

8. The plumbing fixture (1) according to any one of the preceding claims, at least comprising a third connection (14) to the supply line (3) for connecting the supply line (3) to a second water line (15).

9. The plumbing fixture (1) according to claim 8, wherein a second non-return valve (16), which prevents a backflow of liquid or compressed air (11) from the supply line (3) into the second water line (15), is arranged between the third connection (14) and the second water line (15).

10. The plumbing fixture (1) according to any one of the preceding claims, wherein the shower system (2) has a collecting device (17) for the liquid that has exited the outlet (4), wherein the supply line (3) is fluidically connected to the collecting device (17) so that the liquid can be used as a circulating liquid.
